(19) United States
(12) Patent Application Publication
(10) Pub. No.: US 2017/0372818 A1
(43) Pub. Date: Dec. 28, 2017

(54) DIFFERENTIAL SIGNAL TRANSMISSION CABLE AND MULTI-CORE DIFFERENTIAL SIGNAL TRANSMISSION CABLE

(71) Applicant: Hitachi Metals, Ltd., Tokyo (JP)

(72) Inventors: Hiroshi ISHIKAWA, Hitachi (JP); Takahiro SUGIYAMA, Hitachi (JP)

(21) Appl. No.: 15/630,037

(22) Filed: Jun. 22, 2017

(30) Foreign Application Priority Data
Jun. 28, 2016 (JP) 2016-127863

(51) Int. Cl. H01B 11/18; H01B 7/08; H01B 7/18; H01B 7/26

(52) U.S. Cl. CPC H01B 11/1869; H01B 7/26; H01B 7/0861; H01B 7/1875

(57) ABSTRACT

A differential signal transmission cable includes a conductor, a first dielectric covering the conductor, an outer conductor covering the first dielectric, a second dielectric covering the outer conductor and including a material with a higher transmission loss than the first dielectric, and a shield covering the second dielectric. A multi-core differential signal transmission cable includes a plurality of wires each including a conductor, a first dielectric covering the conductor and an outer conductor covering the first dielectric, a second dielectric covering all the plurality of wires and including a material with a higher transmission loss than the first dielectric, and a shield covering the second dielectric.

The present application is based on Japanese patent application No. 2016-127863 filed on Jun. 28, 2016, the entire contents of which are incorporated herein by reference.

### BACKGROUND OF THE INVENTION

### 1. Field of the Invention

The invention relates to a differential signal transmission cable and a multi-core differential signal transmission cable.

### 2. Description of the Related Art

A differential signal transmission cable is known in which a pair of conductors for transmitting differential signals are covered with an insulation (see e.g. JP-B-5214056). In this type of differential signal transmission cable, currents with opposite phases are fed to the pair of conductive wires and a differential signal is thereby transmitted.

The differential signal transmission cable disclosed by JP-B-5214056 uses two layers of shields. Intra-pair skew of the differential signal transmission cable can be reduced without an increase in transmission loss of differential signal by connecting the differential signal transmission cable to an electric device in the state that the inner shield is not connected to anything.

### SUMMARY OF THE INVENTION

The differential signal transmission cables are needed to have a reduced diameter according as information processors etc. are recently reduced in size and increased in density.

It is an object of the invention to provide a differential signal transmission cable that has a reduced diameter, as well as a multi-core differential signal transmission cable with multiple differential signal transmission cables.

[1] According to an embodiment of the invention, a differential signal transmission cable comprises:
a conductor;
a first dielectric covering the conductor;
an outer conductor covering the first dielectric;
a second dielectric covering the outer conductor and comprising a material with a higher transmission loss than the first dielectric; and
a shield covering the second dielectric.

[2] According to another embodiment of the invention, a multi-core differential signal transmission cable comprises:

a plurality of wires each comprising a conductor, a first dielectric covering the conductor and an outer conductor covering the first dielectric; a second dielectric covering all the plurality of wires and comprising a material with a higher transmission loss than the first dielectric; and

a shield covering the second dielectric.

### Effects of the Invention

According to an embodiment of the invention, a differential signal transmission cable can be provided that has a reduced diameter, as well as a multi-core differential signal transmission cable with multiple differential signal transmission cables.

### BRIEF DESCRIPTION OF THE DRAWINGS

Next, the present invention will be explained in more detail in conjunction with appended drawings, wherein:

FIG. 1 is a radial cross sectional view showing a single-core differential signal transmission coaxial cable which is a differential signal transmission cable in the first embodiment;

FIG. 2 is a schematic diagram illustrating an electrical connection structure between the single-core differential signal transmission coaxial cable and a differential board which outputs differential signals;

FIG. 3 is a radial cross sectional view showing an example of a multi-core differential signal transmission cable in the second embodiment; and

FIGS. 4A and 4B are radial cross sectional views showing other examples of the multi-core differential signal transmission cable in the second embodiment.

### DETAILED DESCRIPTION OF THE PREFERRED EMBODIMENTS

### First Embodiment

Configuration of Single-Core Differential Signal Transmission Coaxial Cable

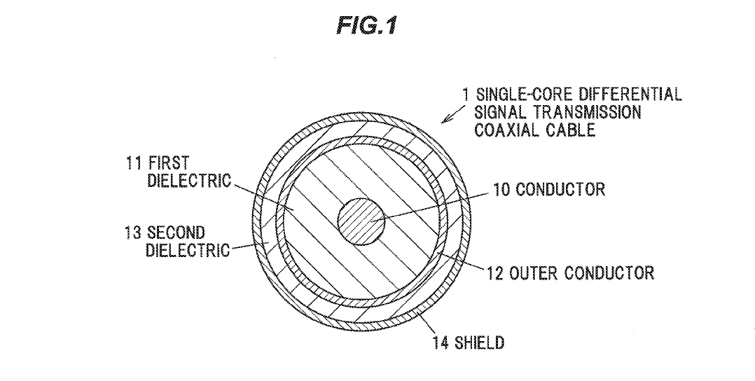

FIG. 1 is a radial cross sectional view showing a single-core differential signal transmission coaxial cable 1 which is a differential signal transmission cable in the first embodiment.

The single-core differential signal transmission coaxial cable 1 has a conductor 10, a first dielectric 11 covering the conductor 10, an outer conductor 12 covering the first dielectric 11, a second dielectric 13 covering the outer conductor 12, and a shield 14 covering the second dielectric 13.

The single-core differential signal transmission coaxial cable 1 is a cable used for transmitting differential signals between, e.g., electronic devices, such as server, router or storage, using differential signals with a frequency of not less than several tens GHz, or used inside such electronic devices.

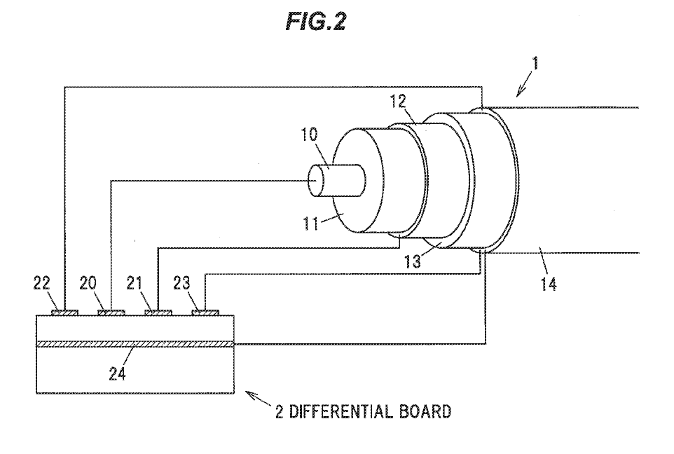

FIG. 2 is a schematic diagram illustrating an electrical connection structure between the single-core differential signal transmission coaxial cable 1 and a differential board 2 which outputs differential signals. The differential board 2 is a circuit board which is provided in, e.g., the above-mentioned electronic device.

The conductor 10 and the outer conductor 12 are signal lines for transmitting differential signals. The conductor 10 is connected to a p-electrode 20 of the differential board 2, and the outer conductor 12 is connected to an n-electrode 21 of the differential board 2. Electric currents are supplied to the conductor 10 and the outer conductor 12 from the differential board 2 so that differential signals propagate through the first dielectric 11 located between the conductor 10 and the outer conductor 12.

The single-core differential signal transmission coaxial cable 1 is a single-core coaxial cable having one conductor 10 as a core, and thus can have a smaller diameter than conventional differential signal transmission cables using a pair of parallel conductors as signal lines. In addition, due to its structure, it is possible to manufacture at a lower cost than the conventional differential signal transmission cables.

In communication using the single-core differential signal transmission coaxial cable 1, currents with opposite phases are supplied to the conductor 10 and the outer conductor 12 so that an electrical potential difference between the conductor 10 and the outer conductor 12 causes a signal to be transmitted.

The conductor 10 is a conductor of copper, etc., of which surface may be plated. When the single-core differential signal transmission coaxial cable 1 is required to have flexibility, a twisted wire formed by twisting plural conductive wires may alternatively be used as the conductor 10.

The outer conductor 12 is, e.g., a copper foil tape spirally wound around the first dielectric 11, or a copper foil film deposited on the surface of the first dielectric 11 by plating.

The first dielectric 11 is formed of, e.g., polyethylene or fluorine resin. The thickness of the first dielectric 11 is determined based on magnitude of characteristic impedance of the differential signal (e.g., 50Ω or 100Ω).

The shield 14 is connected to ground electrodes 22, 23 and 24 of the differential board 2. To the single-core differential signal transmission coaxial cable 1, not only differential signals but also common-mode signals generated in the differential board 2 are input. Most of the common-mode signals propagate through the second dielectric 13 located between the outer conductor 12 and the shield 14.

The shield 14 is formed of, e.g., a metal tape spirally wound around the second dielectric 13. At low frequency, the shield 14 with lower surface transfer impedance is more effective to shield external noise and the shield 14 is thus preferably formed of a low-conductivity material such as aluminum. Meanwhile, at high frequency, the higher the skin resistance of the shield 14, the higher the transmission loss of common-mode signal is. Therefore, the outer surface of the outer conductor 12 (a surface in contact with the second dielectric 13) and the inner surface of the shield 14 may be roughened to increase the transmission loss of common-mode signal.

The second dielectric 13 is formed of a material with higher communication signal transmission loss than the first dielectric 11. The signal transmission loss is proportional to the product of ½ square root of relative permittivity and dielectric loss tangent of the material. In other words, the second dielectric 13 is formed of a material of which product of ½ square root of relative permittivity and dielectric loss tangent is larger than that of the first dielectric 11. Relative permittivity and dielectric loss tangent of the material depend on the frequency of the signal. The relative permittivity and dielectric loss tangent mentioned above are used as a function of signal transmission loss, and thus mean relative permittivity and dielectric loss tangent at the frequency of the communication signal.

The second dielectric 13 is formed of, e.g., a material used to form a general noise suppression sheet. One example of such material is a resin to which magnetic powder such as ferrite powder is added to increase permittivity. The thickness of the second dielectric 13 is preferably as small as possible. When the second dielectric 13 is thinner, characteristic impedance of the common-mode signal becomes lower and transmittance of the common-mode signal is reduced by reflection at the connecting portion between the cable 1 and the differential board 2. The thickness of the second dielectric 13 is preferably determined so that characteristic impedance of the coaxial line formed by the outer conductor 12, the second dielectric 13 and the shield 14 is not more than Rd x 0.25 or not less than Rd x 1, where Rd is characteristic impedance of the differential signal.

In the single-core differential signal transmission coaxial cable 1, attenuation of the differential signal is reduced by using the first dielectric 11 with low transmission loss for propagation of the differential signal, while the common-mode signal is intentionally attenuated by using the second dielectric 13 with high transmission loss for propagation of the common-mode signal.

Meanwhile, the common-mode signal is more likely to be reflected at an end of the single-core differential signal transmission coaxial cable 1 on the differential board 2 side when a difference in characteristic impedance of the common-mode signal between the single-core differential signal transmission coaxial cable 1 and the differential board 2 becomes larger. Therefore, it is possible to reduce the common-mode signals input to the single-core differential signal transmission coaxial cable 1. Effects of the first embodiment

The single-core differential signal transmission coaxial cable 1, which is a differential signal transmission cable in the first embodiment, is a single-core coaxial cable but can transmit differential signals while reflecting or attenuating common-mode signals. In addition, by having a single core, the single-core differential signal transmission coaxial cable 1 can have a smaller diameter than conventional differential signal transmission cables.

### Second Embodiment

The second embodiment relates to a multi-core differential signal transmission cable which has plural single-core differential signal transmission coaxial cables equivalent to the single-core differential signal transmission coaxial cable 1 in the first embodiment. The explanation for the same features as the first embodiment will be omitted or simplified.

Configuration of the Multi-Core Differential Signal Transmission Cable

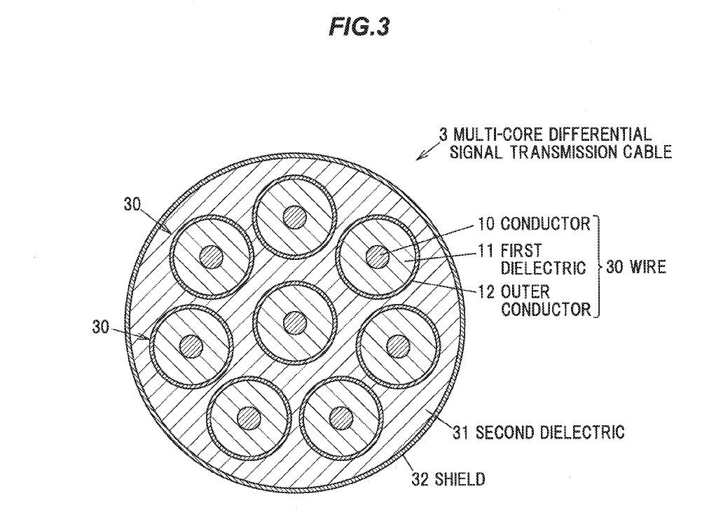

FIG. 3 is a radial cross sectional view showing a multi-core differential signal transmission cable 3 which is an example of a multi-core differential signal transmission cable in the second embodiment.

The multi-core differential signal transmission cable 3 has plural wires 30 each composed of the conductor 10, the first dielectric 11 and the outer conductor 12 which are used in the single-core differential signal transmission coaxial cable 1 in the first embodiment. The bundled plural wires 30 are covered with one second dielectric 31 which is formed of the same material as used for the second dielectric 13 of the single-core differential signal transmission coaxial cable 1 in the first embodiment. Then, the second dielectric 31 is covered with a shield 32 which is formed of the same material as used for the shield 14 of the single-core differential signal transmission coaxial cable 1 in the first embodiment.

The number of the wires 30 is eight in the example shown in FIG. 3 but is not limited thereto, and is preferably, e.g., two, eight or twenty-four.

The plural conductors 10 of the multi-core differential signal transmission cable 3 are connected to the p-electrode 20 of the differential board 2, and the plural outer conductors 12 are connected to the n-electrode 21 of the differential board 2. Electric currents are supplied to the conductors 10 and the outer conductors 12 from the differential board 2 so that differential signals propagate through the first dielectrics 11 located between the conductors 10 and the outer conductors 12. Meanwhile, the shield 32 is connected to the ground electrodes 22, 23 and 24 of the differential board 2. The common-mode signals input from the differential board 2 propagate through the second dielectric 31 located between the outer conductors 12 and the shield 32.

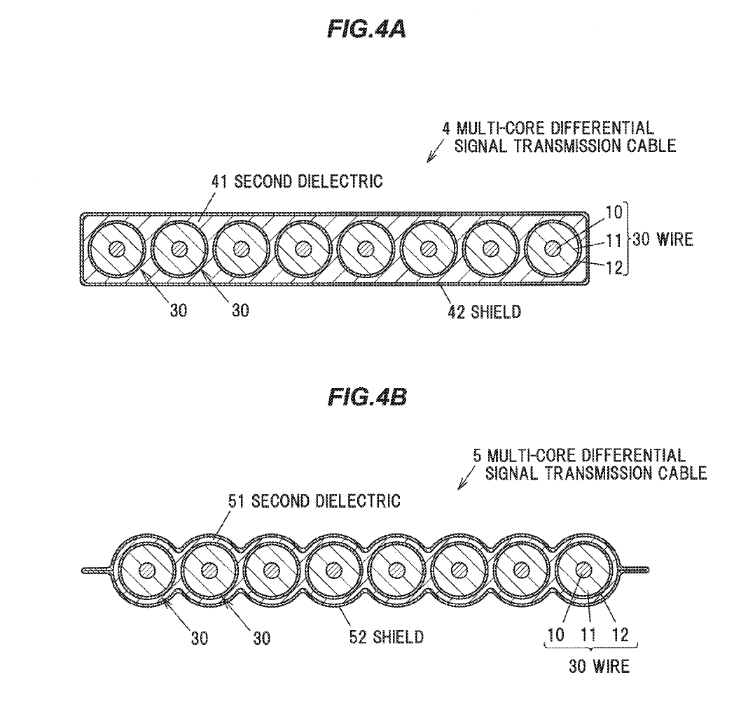

FIGS. 4A and 4B are radial cross sectional views showing multi-core differential signal transmission cables 4 and 5 which are other examples of the multi-core differential signal transmission cable in the second embodiment.

Each of the multi-core differential signal transmission cables 4 and 5 has plural wires 30 in the same manner as the multi-core differential signal transmission cable 3. The multi-core differential signal transmission cables 4 and 5 are flat multi-core cables in which the plural wires 30 are arranged parallel to each other substantially in a row. Here, “parallel to each other substantially in a row” obviously means that the wires 30 are parallel to each other and substantially in a row in the state that the multi-core differential signal transmission cables 4 and 5 are not deformed, e.g., not curved.

In each of the multi-core differential signal transmission cables 4 and 5, plural wires 30 are covered with one second dielectric 41/51 which is formed of the same material as used for the second dielectric 13 of the single-core differential signal transmission coaxial cable 1 in the first embodiment. Then, the second dielectric 41/51 is covered with a shield 42/52 which is formed of the same material as used for the shield 14 of the single-core differential signal transmission coaxial cable 1 in the first embodiment.

The number of the wires 30 is eight in the examples shown in FIGS. 4A and 4B but is not limited thereto, and is preferably, e.g., two, eight or twenty-four.

The plural conductors 10 of each of the multi-core differential signal transmission cables 4 and 5 are connected to the p-electrode 20 of the differential board 2, and the plural outer conductors 12 are connected to the n-electrode 21 of the differential board 2. Electric currents are supplied to the conductors 10 and the outer conductors 12 from the differential board 2 so that differential signals propagate through the first dielectrics 11 located between the conductors 10 and the outer conductors 12.

Meanwhile, the shield 42/52 is connected to the ground electrodes 22, 23 and 24 of the differential board 2. The common-mode signals input from the differential board 2 propagate through the second dielectric 41/51 located between the outer conductors 12 and the shield 42/52.

The multi-core differential signal transmission cables 4 and 5, in each of which the shield 42/52 is shared by plural wires 30, can advantageously have a smaller cable width than when plural single-core differential signal transmission coaxial cables 1 are aligned.

### Effects of the Second Embodiment

The multi-core differential signal transmission cables 3, 4 and 5 are using single-core wires 30 but have the same configuration as the single-core differential signal transmission coaxial cable 1 in the first embodiment, and thus can transmit differential signals while reflecting or attenuating common-mode signals. In addition, since the wires 30 are single-core wires, the multi-core differential signal transmission cables 3, 4 and 5 can have a significantly smaller diameter or width than conventional multi-core differential signal transmission cables having plural two-core differential signal transmission cables.

### Summary of the Embodiment

Technical ideas understood from the embodiment will be described below citing the reference numerals, etc., used for the embodiment. However, each reference numeral, etc., described below is not intended to limit the constituent elements in the claims to the members, etc., specifically described in the embodiment.

[1] A single-core differential signal transmission coaxial cable (1), comprising: a conductor (10); a first dielectric (11) covering the conductor (10); an outer conductor (12) covering the first dielectric (11); a second dielectric (13) covering the outer conductor (12) and comprising a material with a higher transmission loss than the first dielectric (11); and a shield (14) covering the second dielectric (13).

[2] The single-core differential signal transmission coaxial cable (1) defined by [1], wherein the second dielectric (13) comprises a resin containing magnetic powder.

[3] The single-core differential signal transmission coaxial cable (1) defined by [1] or [2], wherein the shield (14) has a lower conductivity than the outer conductor (12).

[4] The single-core differential signal transmission coaxial cable (1) defined by any one of [1] to [3], wherein the outer surface of the outer conductor (12) is roughened.

[5] A multi-core differential signal transmission cable (3, 4, 5), comprising: a plurality of wires (30) each comprising a conductor (10), a first dielectric (11) covering the conductor (10) and an outer conductor (12) covering the first dielectric (11); a second dielectric (31, 41, 51) covering all the plurality of wires (30) and comprising a material with a higher transmission loss than the first dielectric (11); and a shield (32, 42, 52) covering the second dielectric (31, 41, 51).

[6] The multi-core differential signal transmission cable (3, 4, 5) defined by [5], wherein the second dielectric (31, 41, 51) comprises a resin containing magnetic powder.

[7] The multi-core differential signal transmission cable (3, 4, 5) defined by [5] or [6], wherein the outer surfaces of the outer conductors (12) are roughened.

[8] The multi-core differential signal transmission cable (4, 5) defined by any one of [5] to [7], wherein the plurality of wires (30) are arranged parallel to each other in a row.

Although the embodiments of the invention have been described, the invention is not limited thereto and various modifications can be implemented without departing from the gist of the invention.

In addition, the invention according to claims is not to be limited to the embodiments. Further, please note that all combinations of the features described in the embodiments are not necessary to solve the problem of the invention.

What is claimed is:

1. A differential signal transmission cable, comprising:
a conductor;
a first dielectric covering the conductor;
an outer conductor covering the first dielectric;
a second dielectric covering the outer conductor and comprising a material with a higher transmission loss than the first dielectric; and
a shield covering the second dielectric.

2. The differential signal transmission cable according to claim 1, wherein the second dielectric comprises a resin containing magnetic powder.

3. The differential signal transmission cable according to claim 1, wherein the shield has a lower conductivity than the outer conductor.

4. The differential signal transmission cable according to claim 1, wherein an outer surface of the outer conductor is roughened.

5. A multi-core differential signal transmission cable, comprising:
a plurality of wires each comprising a conductor, a first dielectric covering the conductor and an outer conductor covering the first dielectric;
a second dielectric covering all the plurality of wires and comprising a material with a higher transmission loss than the first dielectric; and
a shield covering the second dielectric.

6. The multi-core differential signal transmission cable according to claim 5, wherein the second dielectric comprises a resin containing magnetic powder.

7. The multi-core differential signal transmission cable according to claim 5, wherein outer surfaces of the outer conductors are roughened.

8. The multi-core differential signal transmission cable according to claim 5, wherein the plurality of wires are arranged parallel to each other in a row.
